(19) United States
(12) Patent Application Publication
(10) Pub. No.: US 2003/0067101 A1
(43) Pub. Date: Apr. 10, 2003

(54) Method for forming tool box hinge by blown molding

(76) Inventor: Huang Liu, Wu-Ryh (TW)

Correspondence Address: BACON & THOMAS, PLLC, 625 SLATERS LANE, FOURTH FLOOR, ALEXANDRIA, VA, 22314

(21) Appl. No.: 09/969,791

(22) Filed: Oct. 4, 2001

(51) Int. Cl. B29C 49/04

(52) U.S. Cl. 264/531; 264/545

(57) ABSTRACT

A method is designed to form hinges of a tool box. The method involves a first step in which two heated plastic blanks are arranged between the mold cavities of a molding tool. The molding tool is then closed and provided with the compressed air injected thereinto. The plastic blanks are inflated and molded in the mold cavities such that one or more hinge projections are formed along one side of the blanks. A center pin is advanced into the mold cavities to form in the center of the hinge projections a pin hole. The center pin is then withdrawn from the mold cavities.

### FIELD OF THE INVENTION

The present invention relates generally to a method for forming a tool box hinge, and more particularly to a blown molding method for forming a tool box hinge.

### BACKGROUND OF THE INVENTION

The conventional method for blown-molding a tool box hinge involves a first step in which two heated plastic blanks are arranged respectively between the upper mold and the lower mold of a molding tool. The molding tool is then closed before a compressed air is injected into the molding tool. The compressed air causes the plastic blanks to deform in the mold cavities such that a hinge projection is formed. Upon removal of the tool box from the molding tool, the hinge projection is provided with a pin hole by drilling. The drilling process results in an increase in production cost of the tool box. In addition, the quality control of the drilling process can not be economically executed.

The U.S. Pat. No. 5,288,453 discloses a hinge forming method in which a center pin arranged in the molding tool in advance. As a hinge projection is formed in the molding tool, the center pin is removed, thereby resulting in formation of the hinge pin hole. This prior art method is defective in design in that the pressure of the compressed air is exceedingly large to bring about the collision of the blanks with the center pin, thereby resulting in displacement of the center pin. The control of the formation of the center line of the hinge pin hole is thus difficult. As a result, the rejection rate of the product is high.

### SUMMARY OF THE INVENTION

The primary objective of the present invention is to provide a method for forming a tool box hinge integrally without the drawbacks of the prior art methods described above.

In keeping with the principle of the present invention, the foregoing objective of the present invention is attained by a blown molding method for forming integrally a tool box hinge. The method involves the formation of one or more hinge projections such that a center pin is advanced into the mold cavities to form a pin hole in the projection. As the process of forming the pin hole is completed, the center pin is withdrawn from the mold cavities of the molding tool.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows a schematic view of the product made by the method of the present invention.

FIG. 2 shows a process flow chart of the present invention.

### DETAILED DESCRIPTION OF THE PREFERRED EMBODIMENT

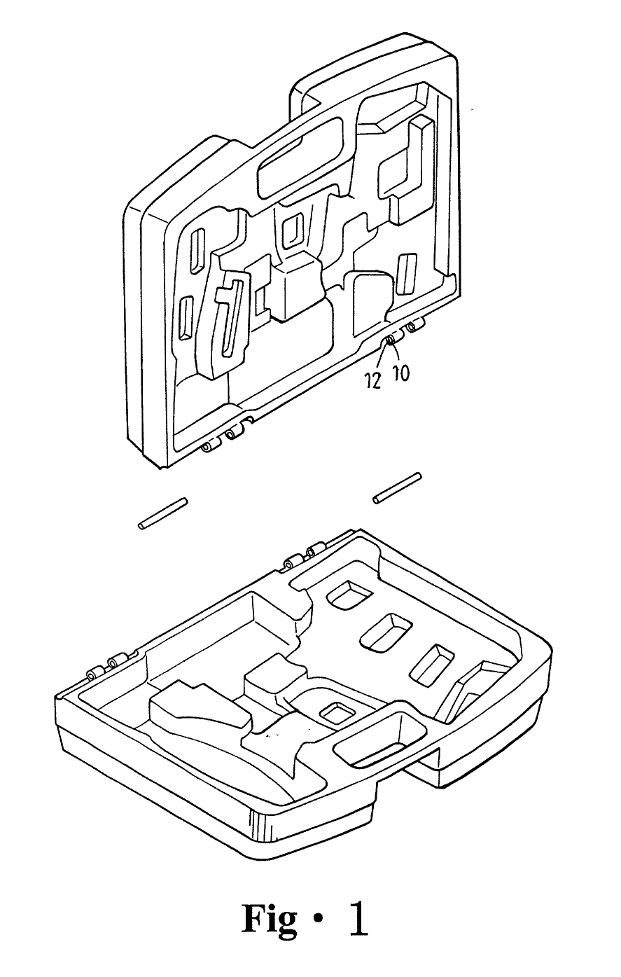

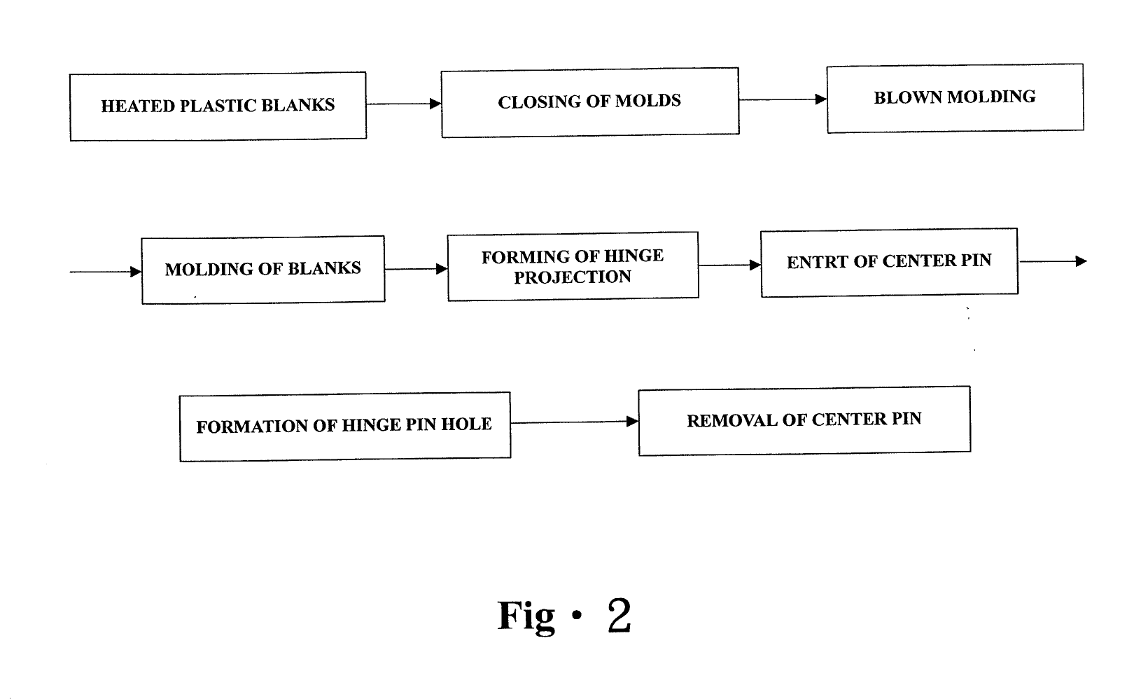

As shown in FIGS. 1 and 2, a method embodied in the present invention is intended to form a tool box hinge projection 10 which is provided with a pin hole 12. The method involves a first step in which two heated plastic blanks are arranged between the upper mold cavity and the lower mold cavity of a molding tool. The molding tool is then closed and provided with a compressed air injected thereinto. The compressed air causes the plastic blanks to inflate to join together, thereby resulting in formation of a plurality of hinge projections 10, as shown in FIG. 1. The hinged projections 10 are provided with a pin hole 12 which is formed by a center pin that is inserted into the mold cavities of the molding tool. Upon completion of the formation of the pin hole 12, the center pin is withdrawn form the mold cavities. The pin holes 12 are aligned.

The embodiment of the present invention described above is to be regarded in all respects as being merely illustrative and nonrestrictive. Accordingly, the present invention may be embodied in other specific forms without deviating from the spirit thereof. The present invention is therefore to be limited only by the scope of the following claim.

What is claimed is:

1. A method for making integrally hinges of a tool box, said method comprising the steps of:
(a) heating two plastic blanks;
(b) arranging the two heated plastic blanks between the upper mold cavity and the lower mold cavity of a molding tool;
(c) closing the molding tool;
(d) injecting the compressed air into the molding tool to cause the plastic blanks to inflate such that the plastic blanks are molded in the mold cavities of the molding tool, and that one or more hinge projections are formed along one side of the blanks;
(e) advancing a center pin into the mold cavities to form in the center of the hinge projections a pin hole; and
(f) withdrawing the center pin from the mold cavities.
